(19) United States
(12) Patent Application Publication
(10) Pub. No.: US 2020/0190304 A1
(43) Pub. Date: Jun. 18, 2020

(54) Method for Forming an Injection Molded Part

(71) Applicant: Celanese International Corporation, Irving, TX (US)

(72) Inventors: Paul Kenny, Holmen, WI (US); Robert Haught, Irving, TX (US)

(21) Appl. No.: 16/713,070

(22) Filed: Dec. 13, 2019

Related U.S. Application Data
(60) Provisional application No. 62/778,946, filed on Dec. 13, 2018.

(51) Int. Cl. C08L 23/12; C08J 5/04; B29C 45/00

(52) U.S. Cl. CPC C08L 23/12; C08J 5/048; C08J 5/043; C08J 5/045; B29K 2023/12; C08L 2205/16; C08L 2310/00; C08J 2323/12; C08J 2401/00; B29C 45/0001

(57) ABSTRACT

A method for forming a shaped part is provided. The method comprises melt blending a first polymer composition and a second polymer composition to form a molten blend, wherein the first polymer composition comprises a plurality of long inorganic fibers distributed within a first polymer matrix and the second polymer composition comprises a plurality of cellulosic fibers distributed within a second polymer matrix. The molten blend is injected into a mold cavity and cooled to form the shaped part.

### CROSS REFERENCE TO RELATED APPLICATION

The present application claims filing benefit of U.S. Provisional Patent Application Ser. No. 62/778,946 having a filing date of Dec. 13, 2018, which is incorporated herein by reference in its entirety.

### BACKGROUND OF THE INVENTION

Polypropylene-based compositions are routinely used to fabricate various types of interior and exterior automotive parts (e.g., dashboard skins, airbag covers, bumper covers, exterior fascia, air dams and other trim pieces). To provide the desired level of strength, particulate fillers (e.g., talc) are often added to the composition. However, these particulate fillers can make the composition relatively brittle, which can in turn result in a higher weight and cost for the resulting part. Various attempts have been made to address these issues, such as using cellulosic fibers as a reinforcement agent. Unfortunately, the energy requirements and cycling times for molding such compositions are relatively high, which significantly increases costs. As such, a need currently exists for a propylene composition that has a relatively high degree of strength, but yet capable of being injection molded in a relatively cost efficient manner.

### SUMMARY OF THE INVENTION

In accordance with one embodiment of the present invention, a method for forming a shaped part is disclosed. The method comprises melt blending a first polymer composition and a second polymer composition to form a molten blend, wherein the first polymer composition comprises a plurality of long inorganic fibers distributed within a first polymer matrix and the second polymer composition comprises a plurality of cellulosic fibers distributed within a second polymer matrix. The molten blend is injected into a mold cavity and cooled to form the shaped part.

Other features and aspects of the present invention are set forth in greater detail below.

### BRIEF DESCRIPTION OF THE DRAWINGS

A full and enabling disclosure of the present invention, including the best mode thereof to one skilled in the art, is set forth more particularly in the remainder of the specification, including reference to the accompanying figures, in which:

FIG. 1 is a schematic illustration of one embodiment of a system that may be used to form the first polymer composition of the present invention;

FIG. 2 is a cross-sectional view of an impregnation die that may be employed in the system shown in FIG. 1;

FIG. 3 is a schematic view of one embodiment of an injection molding system that may be employed in the present invention; and

FIG. 4 is a cross-sectional view of one embodiment of a mold that may be employed in the system shown in FIG. 3.

Repeat use of reference characters in the present specification and drawings is intended to represent the same or analogous features or elements of the present invention.

### DETAILED DESCRIPTION OF REPRESENTATIVE EMBODIMENTS

It is to be understood by one of ordinary skill in the art that the present discussion is a description of exemplary embodiments only, and is not intended as limiting the broader aspects of the present invention.

Generally speaking, the present invention is directed to a method for forming a shaped part (e.g., injection molded part), which typically has a thickness of about 10 millimeters or less, in some embodiments about 6 millimeters or less, in some embodiments about 4 millimeters or less, and in some embodiments, from about 0.4 to about 1.6 millimeters (e.g., 1.2 millimeters). The method includes melt blending a first polymer composition and a second polymer composition to form a molten blend. The first polymer composition comprises a plurality of long inorganic fibers distributed within a first polymer matrix and the second polymer composition comprises a plurality of cellulosic fibers distributed within a second polymer matrix. The molten blend is injected into a mold cavity and cooled within the mold cavity to form the shaped part. By selectively controlling the particular nature and concentration of the components employed, as well as the manner in which they are combined, the present inventors have discovered that a variety of benefits may be achieved.

Due to the unique properties of the combination of the first and second polymer compositions, for instance, the “cooling time” during a molding cycle can be substantially reduced while still achieving the same degree of crystallization. The cooling time can be represented by the “normalized cooling ratio”, which is determined by dividing the total cooling time by the average thickness of the molded part. As a result of the present invention, for example, the normalized cooling ratio may range from about 0.2 to about 8 seconds per millimeter, in some embodiments from about 0.5 to about 6 seconds per millimeter, and in some embodiments, from about 1 to about 5 seconds per millimeter. The total cooling time can be determined from the point when the molten blend is injected into the mold cavity to the point that it reaches an ejection temperature at which it can be safely ejected. Exemplary cooling times may range, for instance, from about 1 to about 60 seconds, in some embodiments from about 5 to about 55 seconds, and in some embodiments, from about 10 to about 50 seconds. The combination of the first and second polymer compositions can also significantly improve the thermal conductivity of the resulting part, which allows it to be molded at lower temperatures. For example, the mold temperature (e.g., temperature of a surface of the mold) may be from about 10° C. to about 60° C., in some embodiments from about 15° C. to about 55° C., and in some embodiments, from about 20° C. to about 50° C. In addition to minimizing the energy requirements for the molding operation, such low mold temperatures and/or short cooling cycles may be accomplished using cooling mediums that are less corrosive and expensive than some conventional techniques. For example, liquid water may be employed as the cooling medium.

Conventionally, it was believed that shaped parts formed with such short cooling cycles and/or low molding temperatures could not also possess sufficiently good mechanical properties. Contrary to conventional thought, however, shaped parts can be formed that still possess excellent mechanical properties. For example, the part may exhibit a Charpy notched impact strength greater than about 6 kJ/m², in some embodiments from about 8 to about 80 kJ/m², and in some embodiments, from about 10 to about 60 kJ/m², measured at according to ISO Test No. 179-1:2010) (technically equivalent to ASTM D256-10e1) at various temperatures, such as −40° C., 23° C., or 80° C. The tensile and flexural mechanical properties may also be good. For example, the part may exhibit a tensile strength of from about 20 to about 300 MPa, in some embodiments from about 40 to about 200 MPa, and in some embodiments, from about 50 to about 150 MPa; a tensile break strain of about 0.5% or more, in some embodiments from about 1% to about 15%, and in some embodiments, from about 2% to about 10%; and/or a tensile modulus of from about 3,500 MPa to about 20,000 MPa, in some embodiments from about 4,000 MPa to about 15,000 MPa, and in some embodiments, from about 5,000 MPa to about 10,000 MPa. The tensile properties may be determined in accordance with ISO Test No. 527-1:2012 (technically equivalent to ASTM D638-14) at −30° C., 23° C., or 80° C. The part may also exhibit a flexural strength of from about 50 to about 500 MPa, in some embodiments from about 80 to about 400 MPa, and in some embodiments, from about 100 to about 250 MPa and/or a flexural modulus of from about 2000 MPa to about 20,000 MPa, in some embodiments from about 3,000 MPa to about 15,000 MPa, and in some embodiments, from about 4,000 MPa to about 10,000 MPa. The flexural properties may be determined in accordance with ISO Test No. 178:2010 (technically equivalent to ASTM D790-15e2) at −30° C., 23° C., or 80° C.

The resulting part may also be generally resistant to aging at high temperatures. For example, the part may be aged in an atmosphere having a temperature of from about 100° C. or more, in some embodiments from about 110° C. to about 200° C., and in some embodiments, from about 120° C. to about 180° C. (e.g., 120° C. or 150° C.) for a time period of about 100 hours or more, in some embodiments from about 300 hours to about 3000 hours, and in some embodiments, from about 400 hours to about 2500 hours (e.g., about 1,000 hours). Even after aging, the mechanical properties (e.g., impact strength, tensile properties, and/or flexural properties) may remain within the ranges noted above. For example, the ratio of a particular mechanical property (e.g., Charpy unnotched impact strength, flexural strength, etc.) after “aging” at 120° C. for 1,000 hours to the initial mechanical property prior to such aging may be about 0.6 or more, in some embodiments about 0.7 or more, and in some embodiments, from about 0.8 to 1.0. In one embodiment, for example, the part may exhibit a Charpy unnotched impact strength after being aged at a high temperature (e.g., 120° C.) for 1,000 hours of greater than about 15 kJ/m², in some embodiments from about 20 to about 80 kJ/m², and in some embodiments, from about 30 to about 60 kJ/m², measured according to ISO Test No. 179-1:2010 at a temperature of 23° C.) (technically equivalent to ASTM D256-10e1). The part may also exhibit a flexural strength after being aged at a high temperature atmosphere (e.g., 120° C.) for 1,000 hours of about 50 to about 500 MPa, in some embodiments from about 80 to about 400 MPa, and in some embodiments, from about 100 to about 250 MPa, measured according to ISO Test No. 178:2010 at a temperature of 23° C. (technically equivalent to ASTM D790-15e2). Likewise, the part may exhibit a tensile strength after being aged at a high temperature atmosphere (e.g., 120° C.) for 1,000 hours of from about 20 to about 300 MPa, in some embodiments from about 30 to about 200 MPa, and in some embodiments, from about 40 to about 150 MPa as determined at a temperature of 23° C. in accordance with ISO Test No. 527-1:2012 (technically equivalent to ASTM D638-14).

The part may also exhibit low emissions of volatile organic compounds. As used herein, the term “volatile compounds” or “volatiles” generally refer to organic compounds that have a relatively high vapor pressure. For example, the boiling point of such compounds at atmospheric pressure (1 atmosphere) may be about 80° C. or less, in some embodiments about 70° C. or less, and in some embodiments, from about 0° C. to about 60° C. One example of such a compound is 2-methyl-1-propene. The part may, for example, exhibit a total volatile content (“VOC”) of about 100 micrograms equivalent carbon per gram of the composition (“μgC/g”) or less, in some embodiments about 70 μg/g or less, in some embodiments about 50 μg/g or less, and in some embodiments, about 40 μg/g or less, as determined in accordance with VDA 277:1995. The part may also exhibit a toluene equivalent volatile content (“TVOC”) of about 250 micrograms equivalent toluene per gram of the composition (“μg/g”) or less, in some embodiments about 150 μg/g or less, and in some embodiments, about 100 μg/g or less, as well as a fogging content (“FOG”) of about 500 micrograms hexadecane per gram of the composition (“μg/g”) or less, in some embodiments about 350 μg/g or less, and in some embodiments, about 300 μg/g or less, each of which may be determined in accordance with VDA 278:2002.

Various embodiments of the present invention will now be described in more detail.

### I. First Polymer Composition

A. Polymer Matrix

The polymer matrix of the first polymer composition generally functions as a continuous phase of the first composition and typically constitutes from about 30 wt. % to about 80 wt. %, in some embodiments from about 35 wt. % to about 75 wt. %, and in some embodiments, from about 40 wt. % to about 70 wt. % of the first polymer composition. The polymer matrix may contain a variety of different polymers as is known in the art, such as polyolefins (e.g., propylene polymers, ethylene polymers, etc.), polyamides, polyesters, polyesteramides, polycarbonates, polyarylene sulfides, polyetherketones, etc.

In one embodiment, for instance, the polymer matrix contains one or more propylene polymers. Any of a variety of propylene polymers or combinations of propylene polymers may generally be employed, such as propylene homopolymers (e.g., syndiotactic, atactic, isotactic, etc.), propylene copolymers (e.g., block copolymer, random copolymer, heterophase copolymers, etc.), and so forth. In one embodiment, for instance, a propylene polymer may be employed that is an isotactic or syndiotactic homopolymer. The term “syndiotactic” generally refers to a tacticity in which a substantial portion, if not all, of the methyl groups alternate on opposite sides along the polymer chain. On the other hand, the term “isotactic” generally refers to a tacticity in which a substantial portion, if not all, of the methyl groups are on the same side along the polymer chain. Such homopolymers may have a melting point of from about 160° C. to about 170° C. In yet other embodiments, a copolymer of propylene with an a-olefin monomer may be employed. Specific examples of suitable a-olefin monomers may include ethylene, 1-butene; 3-methyl-1-butene; 3,3-dimethyl-1-butene; 1-pentene; 1-pentene with one or more methyl, ethyl or propyl substituents; 1-hexene with one or more methyl, ethyl or propyl substituents; 1-heptene with one or more methyl, ethyl or propyl substituents; 1-octene with one or more methyl, ethyl or propyl substituents; 1-nonene with one or more methyl, ethyl or propyl substituents; ethyl, methyl or dimethyl-substituted 1-decene; 1-dodecene; and styrene. Ethylene is particularly suitable. The overall propylene content of such copolymers may be from about 60 wt. % to about 99 wt. %, in some embodiments from about 70 wt. % to about 97 wt. %, and in some embodiments, from about 80 wt. % to about 95 wt. %. Likewise, the overall a-olefin content may likewise range from about 1 wt. % to about 40 wt. %, in some embodiments from about 3 wt. % to about 30 wt. %, and in some embodiments, from about 5 wt. % to about 20 wt. %.

In certain embodiments, the propylene polymer may be a heterophase copolymer that is formed from at least two components—i.e., a matrix phase and dispersed phase. The matrix phase typically includes an isotactic propylene homopolymer, though an a-olefin comonomer may be used in relatively small amounts, such as about 10 wt. % or less, in some embodiments about 6 wt. % or less, and in some embodiments, about 4 wt. % or less. While by no means required, the inclusion of a small amount of comonomer may result in a product with lower stiffness but with higher impact strength. Regardless of the particular polymer employed, the matrix phase typically has a low xylene solubles content, such as about 3 wt. % or less, in some embodiments about 2 wt. % or less, and in some embodiments, about 1.5 wt. % or less. The dispersed phase typically includes a propylene/a-olefin copolymer such as described above (e.g., propylene/ethylene copolymer). In the dispersed phase, the a-olefin content is generally present at a higher level than the overall content of the copolymer as noted above. For instance, the a-olefin content of the dispersed phase may be from about 40 wt. % to about 90 wt. %, in some embodiments from about 45 wt. % to about 85 wt. %, and in some embodiments, from about 50 wt. % to about 80 wt. %. Likewise, the propylene content of the dispersed phase may range from about 10 wt. % to about 60 wt. %, in some embodiments from about 15 wt. % to about 55 wt. %, and in some embodiments, from about 20 wt. % to about 50 wt. %. While such heterophase copolymers can be produced by melt compounding the individual polymer components, it is typically desired that they are made in a reactor. This is conveniently accomplished by polymerizing propylene in a first reactor and transferring the high crystalline propylene homopolymer from the first reactor into a secondary reactor where propylene and the a-olefin monomer (e.g., ethylene) are copolymerized in the presence of the homopolymer. Any of a variety of known catalyst systems may generally be employed to form the propylene polymers. For instance, the polymers may be formed using a free radical or a coordination catalyst (e.g., Ziegler-Natta) or a single-site coordination catalyst (e.g., metallocene catalyst).

The propylene polymer typically has a melt flow index of from about 20 to about 300 grams per 10 minutes or more, in some embodiments from about 50 to about 250 grams per 10 minutes or less, and in some embodiments, from about 80 to about 160 grams per 10 minutes, as determined in accordance with ISO 1133-1:2011 (technically equivalent to ASTM D1238-13) at a load of 2.16 kg and temperature of 230° C. Further, the propylene polymer may also exhibit a high degree of impact resistance. In this regard, the polymer may exhibit an Izod notched impact strength of greater than about 20 kJ/m², in some embodiments from about 30 to about 100 kJ/m², and in some embodiments, from about 40 to about 80 kJ/m², measured at 23° C. according to ISO Test No. 180:2000 (technically equivalent to ASTM D256-10e1). Notably, the polymer may retain a substantial portion of this strength even at extreme temperatures. For example, the ratio of the Izod notched impact strength at −20° C. to the impact strength at 23° C. may be about 0.6 or more, in some embodiments about 0.6 or more, and in some embodiments, from about 0.7 to 1.0. In one embodiment, for example, the propylene polymer may exhibit an Izod notched impact strength at −20° C. of greater than about 15 kJ/m², in some embodiments from about 20 to about 80 kJ/m², and in some embodiments, from about 30 to about 50 kJ/m², measured at 23° C. according to ISO Test No. 180:2000 (technically equivalent to ASTM D256-10e1).

In addition to a propylene polymer, the polymer matrix may also contain a variety of other components. Examples of such optional components may include, for instance, compatibilizers, stabilizers (e.g., ultraviolet light stabilizer, light stabilizers, heat stabilizers, etc.), antioxidants, particulate fillers, lubricants, colorants, flow modifiers, and other materials added to enhance properties and processability. In certain embodiments, for instance, the polymer composition may contain a pigment, such as titanium dioxide, ultramarine blue, cobalt blue, phthalocyanines, anthraquinones, carbon black, metallic pigment etc., as well as mixtures thereof. Such pigments typically constitute from about 0.01 to about 3 wt. %, and in some embodiments, from about 0.5 wt. % to about 2 wt. % of the composition.

Light stabilizers may also be employed in certain embodiments of the present invention, such as in an amount of from about 0.01 to about 6 wt. %, in some embodiments from about 0.1 wt. % to about 4 wt. %, and in some embodiments, from about 0.5 wt. % to about 3 wt. % of the polymer composition. Particularly suitable light stabilizers for use in the polymer composition are sterically hindered amines, which are typically oligomeric compounds that are N-methylated. Examples of such light stabilizers include, for instance, 2,2,6,6-tetramethyl-4-piperidyl compounds, e.g., bis(2,2,6,6-tetramethyl-4-piperidyl) sebacate (Tinuvin 770, BASF) or the polymer of dimethyl succinate, 1-(2-hydroxyethyl)-4-hydroxy-2,2,6,6-tetramethyl-4-piperidine (Tinuvin 622, BASF), bis(1,2,2,6,6-pentamethyl-4-piperidinyl)-[[3,5-bis(1,1-dimethylethyl)-4-hydroxyphenyl]methyl]butylmalonate (Tinuvin PA 144), or 3,9-bis(2-hydroxy-1,1-dimethylethyl)-2,4,8,10-tetraoxaspiro[5,5]undecane (Adeka Stab LA 63P).

Ultraviolet light stabilizers may also be employed, such in an amount of from about 0.01 to about 6 wt. %, in some embodiments from about 0.1 wt. % to about 4 wt. %, and in some embodiments, from about 0.5 wt. % to about 3 wt. % of the polymer composition. Suitable ultraviolet light stabilizers may include, for instance, benzophenones, benzotriazoles, benzoates, etc. Particular examples of ultraviolet light stabilizers include 2,4-dihydroxy benzophenone, 2-hydroxy-4-methoxybenzophenone, 2-(2′-hydroxy-3′,5′-di-t-butylphenyl)benzotriazole, 2-(2′-hydroxy-3′-t-butyl-5′-methylphenyl)-5-chlorobenzotriazole, 2,4-dihydroxybenzophenone, 2-hydroxy-4-methoxybenzophenone, 2-hydroxy-4-octoxybenzophenone, and 5,5′-methylene bis(2-hydroxy-4-methoxybenzophenone); 2-(2′-hydroxyphenyl)benzotriazoles, e.g., 2-(2′-hydroxy-5′-methylphenyl)benzotriazole, 2-(2′-hydroxy-5′-t-octylphenyl)benzotriazole, 2-(2′-hydroxy-3′,5′-di-t-butylphenyl)benzotriazole, 2-(2′-hydroxy-3′,5′-di-t-butylphenyl)-5-chlorobenzotriazole, 2-(2′-hydroxy-3′-t-butyl-5′-methylphenyl)-5-chlorobenzotriazole, 2-(2′-hydroxy-3′,5′-dicumylphenyl)benzotriazole, and 2,2′-methylene bis(4-t-octyl-6-benzotriazolyl)phenol, phenylsalicylate, resorcinol monobenzoate, 2,4-di-t-butylphenyl-3′,5′-di-t-butyl-4′-hydroxybenzoate, and hexadecyl-3,5-di-t-butyl-4-hydroxybenzoate; substituted oxanilides, e.g., 2-ethyl-2′-ethoxyoxanilide and 2-ethoxy-4′-dodecyloxanilide; cyanoacrylates, e.g., ethyl-a-cyano-β,β-diphenylacrylate and methyl-2-cyano-3-methyl-3-(p-methoxyphenyl)acrylate, or mixtures thereof.

Antioxidants may also be employed in amount of from about 0.01 to about 6 wt. %, in some embodiments from about 0.1 wt. % to about 4 wt. %, and in some embodiments, from about 0.5 wt. % to about 3 wt. % of the polymer composition. Particularly suitable antioxidants are sterically hindered phenol compounds. Examples of such compounds include, for instance, pentaerythrityl tetrakis[3-(3,5-di-tert-butyl-4-hydroxyphenyl)propionate] (Irganox 1010, BASF), triethylene glycol bis[3-(3-tert-butyl-4-hydroxy-5-methylphenyl)propionate] (Irganox 245, BASF), 3,3′-bis[3-(3,5-di-tert-butyl-4-hydroxyphenyl)-propionohydrazide] (Irganox MD 1024, BASF), hexamethylene glycol bis[3-(3,5-di-tert-butyl-4-hydroxyphenyl)propionate] (Irganox 259, BASF), and 3,5-di-tert-butyl-4-hydroxytoluene (Lowinox BHT, Chemtura).

If desired, a compatibilizer may also be employed to enhance the degree of adhesion between the long fibers with the propylene polymer. When employed, such compatibilizers typically constitute from about 0.1 wt. % to about 15 wt. %, in some embodiments from about 0.5 wt. % to about 10 wt. %, and in some embodiments, from about 1 wt. % to about 5 wt. % of the polymer composition. In certain embodiments, the compatibilizer may be a polyolefin compatibilizer that contains a polyolefin that is modified with a polar functional group. The polyolefin may be an olefin homopolymer (e.g., polypropylene) or copolymer (e.g., ethylene copolymer, propylene copolymer, etc.). The functional group may be grafted onto the polyolefin backbone or incorporated as a monomeric constituent of the polymer (e.g., block or random copolymers), etc. Particularly suitable functional groups include maleic anhydride, maleic acid, fumaric acid, maleimide, maleic acid hydrazide, a reaction product of maleic anhydride and diamine, dichloromaleic anhydride, maleic acid amide, etc.

Regardless of the particular components employed, the raw materials (e.g., propylene polymer, light stabilizers, compatibilizers, etc.) are typically melt blended together prior to being reinforced with the long fibers. The raw materials may be supplied either simultaneously or in sequence to a melt-blending device that dispersively blends the materials. Batch and/or continuous melt blending techniques may be employed. For example, a mixer/kneader, Banbury mixer, Farrel continuous mixer, single-screw extruder, twin-screw extruder, roll mill, etc., may be utilized to blend the materials. One particularly suitable melt-blending device is a co-rotating, twin-screw extruder (e.g., ZSK-30 twin-screw extruder available from Werner & Pfleiderer Corporation of Ramsey, N.J.). Such extruders may include feeding and venting ports and provide high intensity distributive and dispersive mixing. For example, the propylene polymer may be fed to a feeding port of the twin-screw extruder and melted. Regardless of the particular melt blending technique chosen, the raw materials may be blended under high shear/pressure and heat to ensure sufficient mixing. For example, melt blending may occur at a temperature of from about 150° C. to about 300° C., in some embodiments, from about 155° C. to about 250° C., and in some embodiments, from about 160° C. to about 220° C.

If desired, a blend of polymers may also be employed within the polymer matrix (e.g., propylene homopolymers and/or propylene/a-olefin copolymers). In such embodiments, each of the polymers employed in the blend may be melt blended in the manner described above. In yet other embodiments, however, it may be desired to melt blend a first propylene polymer (e.g., homopolymer or copolymer) to form a concentrate, which is then reinforced with long fibers in the manner described below to form a precursor composition. The precursor composition may thereafter be blended (e.g., dry blended) with a second propylene polymer to form the first polymer composition. It should also be understood that additional polymers can also be added during prior to and/or during reinforcement of the polymer matrix with the long fibers.

B. Long Inorganic Fibers

The first polymer composition also contains long inorganic fibers that are distributed within the polymer matrix. Typically, such fibers constitute from about 20 wt. % to about 70 wt. %, in some embodiments from about 25 wt. % to about 65 wt. %, and in some embodiments, from about 30 wt. % to about 60 wt. % of the second polymer composition. The term “long fibers” generally refers to fibers, filaments, yarns, or rovings (e.g., bundles of fibers) that are not continuous and have a length of from about 1 to about 25 millimeters, in some embodiments, from about 1.5 to about 20 millimeters, in some embodiments from about 2 to about 15 millimeters, and in some embodiments, from about 3 to about 12 millimeters. As noted above, due to the unique properties of the composition, a substantial portion of the fibers may maintain a relatively large length even after being formed into a shaped part (e.g., injection molding). That is, the median length (D50) of the fibers in the composition may be about 1 millimeter or more, in some embodiments about 1.5 millimeters or more, in some embodiments about 2.0 millimeters or more, and in some embodiments, from about 2.5 to about 8 millimeters.

The inorganic fibers may be formed from any conventional material known in the art, such as glass fibers (e.g., E-glass, A-glass, C-glass, D-glass, AR-glass, R-glass, S1-glass, S2-glass), boron fibers, ceramic fibers (e.g., alumina or silica), etc. Glass fibers are particularly desirable. Such fibers often have a nominal diameter of about 4 to about 35 micrometers, and in some embodiments, from about 9 to about 35 micrometers, such as determined using laser diffraction techniques in accordance with ISO 13320:2009 (e.g., with a Horiba LA-960 particle size distribution analyzer). The fibers may be twisted or straight. If desired, the fibers may be in the form of rovings (e.g., bundle of fibers) that contain a single fiber type or different types of fibers. Different fibers may be contained in individual rovings or, alternatively, each roving may contain a different fiber type. For example, in one embodiment, certain rovings may contain carbon fibers, while other rovings may contain glass fibers. The number of fibers contained in each roving can be constant or vary from roving to roving. Typically, a roving may contain from about 1,000 fibers to about 50,000 individual fibers, and in some embodiments, from about 2,000 to about 40,000 fibers.

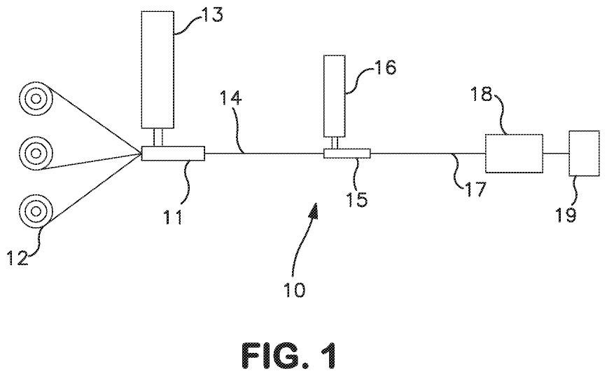

Any of a variety of different techniques may generally be employed to incorporate the fibers into the polymer matrix. The long fibers may be randomly distributed within the polymer matrix, or alternatively distributed in an aligned fashion. In one embodiment, for instance, continuous fibers may initially be impregnated into the polymer matrix to form strands, which are thereafter cooled and then chopped into pellets to that the resulting fibers have the desired length for the long fibers. In such embodiments, the polymer matrix and continuous fibers (e.g., rovings) are typically pultruded through an impregnation die to achieve the desired contact between the fibers and the polymer. Pultrusion can also help ensure that the fibers are spaced apart and oriented in a longitudinal direction that is parallel to a major axis of the pellet (e.g., length), which further enhances the mechanical properties. Referring to FIG. 1, for instance, one embodiment of a pultrusion process 10 is shown in which a polymer matrix is supplied from an extruder 13 to an impregnation die 11 while continuous fibers 12 are a pulled through the die 11 via a puller device 18 to produce a composite structure 14. Typical puller devices may include, for example, caterpillar pullers and reciprocating pullers. While optional, the composite structure 14 may also be pulled through a coating die 15 that is attached to an extruder 16 through which a coating resin is applied to form a coated structure 17. As shown in FIG. 1, the coated structure 17 is then pulled through the puller assembly 18 and supplied to a pelletizer 19 that cuts the structure 17 into the desired size for forming the long fiber-reinforced composition.

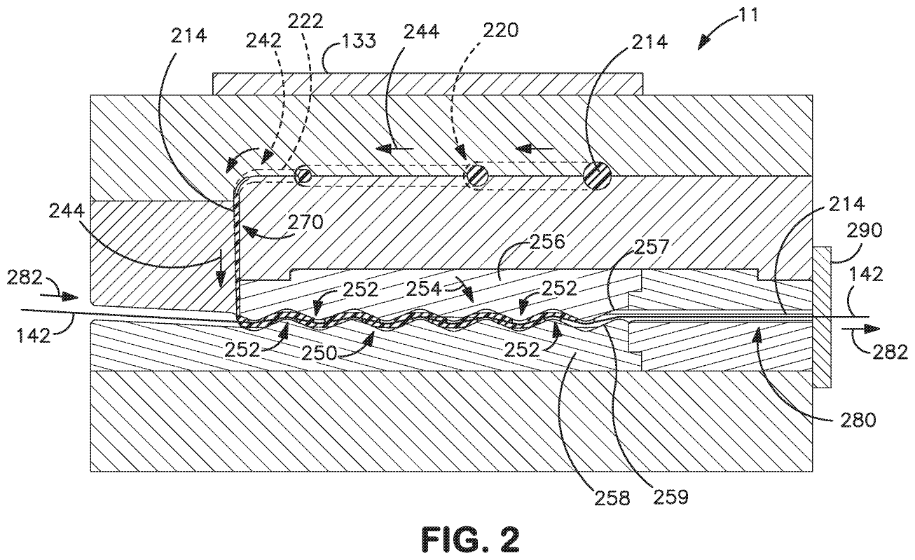

The nature of the impregnation die employed during the pultrusion process may be selectively varied to help achieved good contact between the polymer matrix and the long fibers. Examples of suitable impregnation die systems are described in detail in Reissue Patent No. 32,772 to Hawley; 9,233,486 to Regan, et al.; and 9,278,472 to Eastep, et al. Referring to FIG. 2, for instance, one embodiment of such a suitable impregnation die 11 is shown. As shown, a polymer matrix 214 may be supplied to the impregnation die 11 via an extruder (not shown) and optionally heated inside the die by a heater 133. The die is generally operated at temperatures that are sufficient to cause and/or maintain the proper melt temperature for the polymer, thus allowing for the desired level of impregnation of the rovings by the polymer. The polymer matrix 214 flows into the die 11 as indicated by resin flow direction 244. The polymer matrix 214 is distributed within the die 11 and then interacts with fibers 142 (e.g., fiber rovings), which are are traversed through the die 11 in roving run direction 282 and coated with the polymer matrix 214.

The impregnation die 11 may also include a manifold assembly 220 and an impregnation section. Within the impregnation section, it is generally desired that the fibers 142 are traversed through an impregnation zone 250 to impregnate the rovings with the polymer matrix 214. The impregnation zone 250 may be defined between two spaced apart opposing impregnation plates 256 and 258. First plate 256 defines a first inner surface 257, while second plate 258 defines a second inner surface 259. The contact surfaces 252 may be defined on or extend from both the first and second inner surfaces 257 and 259, or only one of the first and second inner surfaces 257 and 259. Angle 254 at which the fibers 142 traverse the contact surfaces 252 may be generally high enough to enhance shear and pressure, but not so high to cause excessive forces that will break the fibers. Thus, for example, the angle 254 may be in the range between approximately 1° and approximately 30°, and in some embodiments, between approximately 5° and approximately 25°. Within the impregnation zone 250, the polymer matrix may be forced generally transversely through the rovings by shear and pressure created in the impregnation zone 250, which significantly enhances the degree of impregnation. Typically, the die 11 will include a plurality of contact surfaces 252, such as for example at least 2, at least 3, from 4 to 7, from 2 to 20, from 2 to 30, from 2 to 40, from 2 to 50, or more contact surfaces 252, to create a sufficient degree of penetration and pressure on the fibers 142. The impregnation section may also include one or more channels 222 through which the polymer matrix 214 can flow. After flowing through the manifold assembly 220, the polymer matrix 214 may flow through a gate passage 270 and the impregnated fibers 142 may exit through outlet region 242. If desired, a land zone 280 may be positioned downstream of the impregnation zone 250 in run direction 282 of the fibers 142. The fibers 142 may traverse through the land zone 280 before exiting the die 11. Further, a faceplate 290 may adjoin or be adjacent to the impregnation zone 250 to meter excess polymer 214 from the fibers 142. The faceplate 290 may be positioned downstream of the impregnation zone 250 and, if included, the land zone 280, in the run direction 282. The faceplate 290 may contact other components of the die 11, such as the impregnation zone 250 or land zone 280, or may be spaced therefrom.

To further facilitate impregnation, the fibers may also be kept under tension while present within the impregnation die. The tension may, for example, range from about 5 to about 300 Newtons, in some embodiments from about 50 to about 250 Newtons, and in some embodiments, from about 100 to about 200 Newtons per tow of fibers. Furthermore, the fibers may also pass impingement zones in a tortuous path to enhance shear. For example, in the embodiment shown in FIG. 2, the fibers traverse over the impingement zones in a sinusoidal-type pathway. The angle at which the rovings traverse from one impingement zone to another is generally high enough to enhance shear, but not so high to cause excessive forces that will break the fibers. Thus, for example, the angle may range from about 1° to about 30°, and in some embodiments, from about 5° to about 25°.

The impregnation die shown and described above is but one of various possible configurations that may be employed in the present invention. In alternative embodiments, for example, the fibers may be introduced into a crosshead die that is positioned at an angle relative to the direction of flow of the polymer melt. As the fibers move through the crosshead die and reach the point where the polymer exits from an extruder barrel, the polymer is forced into contact with the fibers. It should also be understood that any other extruder design may also be employed, such as a twin screw extruder. Still further, other components may also be optionally employed to assist in the impregnation of the fibers. For example, a “gas jet” assembly may be employed in certain embodiments to help uniformly spread a bundle or tow of individual fibers, which may each contain up to as many as 24,000 fibers, across the entire width of the merged tow. This helps achieve uniform distribution of strength properties in the ribbon. Such an assembly may include a supply of compressed air or another gas that impinges in a generally perpendicular fashion on the moving fiber tows that pass across the exit ports. The spread fiber bundles may then be introduced into a die for impregnation, such as described above.

### II. Second Polymer Composition

The polymer matrix of the second polymer composition generally functions as a continuous phase of the composition and typically constitutes from about 60 wt. % to about 95 wt. %, in some embodiments from about 65 wt. % to about 90 wt. %, and in some embodiments, from about 70 wt. % to about 85 wt. % of the second polymer composition. The polymer matrix may contain a variety of different polymers as is known in the art, such as polyolefins (e.g., propylene polymers, ethylene polymers, etc.), polyamides, polyesters, polyesteramides, polycarbonates, polyarylene sulfides, polyetherketones, etc. In one embodiment, for instance, the polymer matrix contains a propylene polymer such as described in more detail above. It should be understood that the polymer(s) employed in the polymer matrices of the first and second polymer composition may be the same or different. In certain embodiments, for instance, each of the first and second compositions may employ the same type of propylene polymer to enhance their overall compatibility when blended together. As noted above, the polymer matrix may also contain other additives, such as light stabilizers, compatibilizers, etc.

In addition to the polymer matrix, the second polymer composition also contains cellulosic fibers distributed therein. Typically, such fibers constitute from about 5 wt. % to about 40 wt. %, in some embodiments from about 10 wt. % to about 35 wt. %, and in some embodiments, from about 15 wt. % to about 30 wt. % of the second polymer composition. The particular nature of the cellulosic fibers may vary as is known to those skilled in the art. For example, the cellulosic fibers may include natural fibers that are derived from plants, such as hemp, flax, sisal, kenaf, etc., or combinations. The cellulosic fibers may have a relatively small median diameter, such as about 50 micrometers or less, in some embodiments from about 0.1 to about 35 micrometers, and in some embodiments, from about 2 to about 20 micrometers, such as determined using laser diffraction techniques in accordance with ISO 13320:2009 (e.g., with a Horiba LA-960 particle size distribution analyzer). The average length of the cellulosic fibers may range from about 1 millimeter or less, in some embodiments 10 to about 8,000 micrometers, in some embodiments from about 100 to about 5,000 micrometers, and in some embodiments, from about 300 to about 2,000 micrometers. The cellulosic fibers may also have a relatively high aspect ratio (average length divided by nominal diameter), such as from about 1 to about 100, in some embodiments from about 10 to about 60, and in some embodiments, from about 30 to about 50. The manner in which the cellulosic fibers are embedded within the polymer matrix may vary as desired. In certain embodiments, for instance, the cellulosic fibers are combined with the polymer matrix in a melt-blending device (e.g., extruder), such as described above.

### III. Injection Molding

As indicated above, the first and second polymer compositions are melt blended together to form a molten blend, which is then injected into a mold cavity to form the desired shaped part. The relative amount of the first and second polymer compositions may be varied to help achieve the desired properties for the shaped part. In one embodiment, for instance, the weight ratio of the second polymer composition to the first polymer composition may be from about 1:1 to about 10:1, in some embodiments from about 1.5:1 to about 8:1, and in some embodiments, from about 2:1 to about 5:1. For instance, the first polymer composition may constitute from about 5 wt. % to about 50 wt. %, in some embodiments from about 10 wt. % to about 45 wt. %, and in some embodiments, from about 20 wt. % to about 40 wt. % of the molten blend, while the second polymer composition may constitute from about 50 wt. % to about 95 wt. %, in some embodiments from about 55 wt. % to about 90 wt. %, and in some embodiments, from about 60 wt. % to about 80 wt. % of the molten blend. Of course, if desired, other polymer compositions may also be blended with the first and second polymer compositions. In certain embodiments, for instance, a third polymer composition may be employed that contains one or more polymers and that is generally free of fibers (e.g., inorganic fibers, cellulosic fibers, etc.). The nature of the polymers employed may vary as described above. In one embodiment, for instance, the third polymer composition contains a propylene polymer. When employed, the weight ratio of the first polymer composition to the third polymer composition may be from about 1:1 to about 10:1, in some embodiments from about 1.5:1 to about 8:1, and in some embodiments, from about 2:1 to about 5:1. For instance, the first polymer composition may constitute from about 30 wt. % to about 80 wt. %, in some embodiments from about 40 wt. % to about 75 wt. %, and in some embodiments, from about 50 wt. % to about 70 wt. % of the molten blend, while the second and third polymer composition may each independently constitute from about 10 wt. % to about 35 wt. %, in some embodiments from about 12 wt. % to about 30 wt. %, and in some embodiments, from about 15 wt. % to about 25 wt. % of the molten blend.

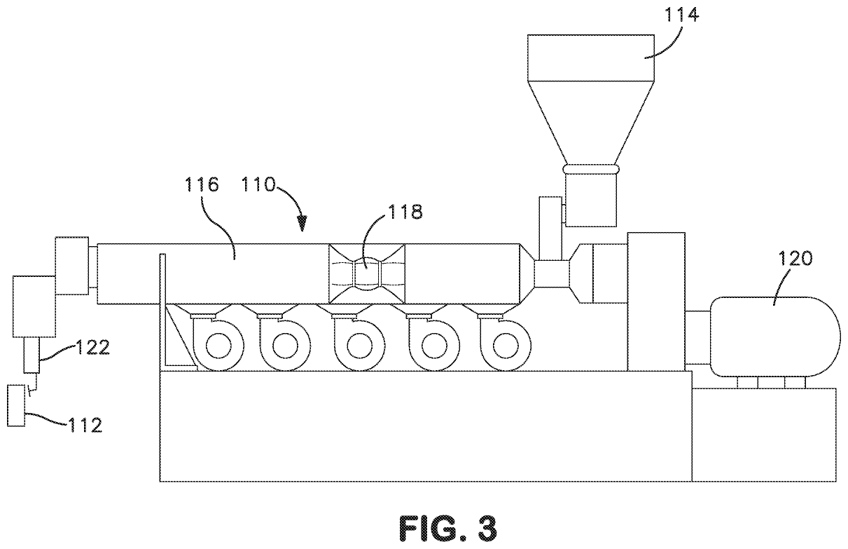

As is known in the art, injection of the molten blend into a mold can occur in two main phases—i.e., an injection phase and holding phase. During the injection phase, the mold cavity is filled with the molten blend. The holding phase is initiated after completion of the injection phase in which the holding pressure is controlled to pack additional material into the cavity and compensate for volumetric shrinkage that occurs during cooling. After the shot has built, it can then be cooled. Once cooling is complete, the molding cycle is completed when the mold opens and the part is ejected, such as with the assistance of ejector pins within the mold. Referring to FIG. 3, one particular embodiment of an injection system 110 that may be employed to form the shaped part is shown in more detail. In the embodiment illustrated, the compositions are each initially supplied to a hopper 114, although separate hoppers may also be employed for each respective composition. If desired, gravimetric or volumetric feed systems may be employed to feed the compositions to the hopper 114. In fact, in certain embodiments, gravimetric feed systems may be particularly suitable for accurately controlling the weight percentage of compositions being fed. In any event, the system 110 may also include a barrel 116 that contains a heater and at least one feed screw 118 that is rotated by a motor 120 for conveying the molten blend of the first and second compositions into a flow path 122. From the flow path 122, the molten blend is injected into a cavity of the mold 112 for producing the shaped part.

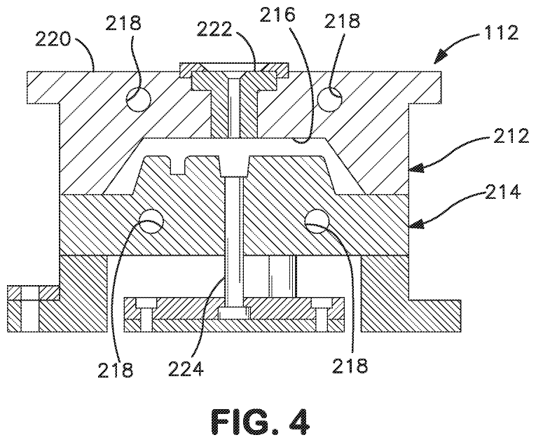

Any suitable mold may generally be employed in the present invention. Referring to FIG. 4, for example, one embodiment of mold 112 that may be employed in the present invention is shown. In this embodiment, the mold 112 includes a first mold base 212 and a second mold base 214, which together define an article or component-defining mold cavity 216. The mold 112 also includes a resin flow path that extends from an outer exterior surface 220 of the first mold half 212 through a sprue 222 to a mold cavity 216. The resin flow path may also include a runner and a gate, both of which are not shown for purposes of simplicity. If desired, one or more ejector pins 224 may also be employed that are slidably secured within the second mold half 214 to define the mold cavity 216 in the closed position of the mold 112. The ejector pins 224 operate in a well-known fashion to remove a molded part from the cavity 216 in the open position of the mold 112. A cooling mechanism may also be provided to solidify the molten compositions within the mold cavity. In FIG. 4, for instance, the mold bases 212 and 214 each include one or more cooling lines 218 through which a cooling medium flows to impart the desired mold temperature to the surface of the mold bases for solidifying the molten material.

The resulting shaped part generally contains a combination of long inorganic fibers, cellulosic fibers, and a polymer matrix. Cellulosic fibers may, for instance, constitute from about 1 wt. % to about 30 wt. %, in some embodiments from about 4 wt. % to about 25 wt. %, and in some embodiments, from about 5 wt. % to about 20 wt. % of the shaped part, while long inorganic fibers typically constitute from about 2 wt. % to about 30 wt. %, in some embodiments from about 5 wt. % to about 25 wt. %, and in some embodiments, from about 8 wt. % to about 20 wt. % of the shaped part. Likewise, the polymer matrix, which contains one or more types of polymers (e.g., propylene polymers) derived from the first and second polymer compositions, typically constitutes from about 30 wt. % to about 90 wt. %, in some embodiments from about 35 wt. % to about 90 wt. %, and in some embodiments, from about 40 wt. % to about 85 wt. % of the shaped part.

A wide variety of products may also be formed from a shaped part formed in accordance with the present invention. For example, the present inventors have discovered that the shaped part is particularly suitable for use in interior and exterior automotive products. Suitable exterior automotive products may include fan shrouds, sunroof systems, door panels, front end modules, side body panels, underbody shields, bumper panels, cladding (e.g., near the rear door license plate), cowls, spray nozzle body, capturing hose assembly, pillar cover, rocker panel, etc. Likewise, suitable interior automotive products that may be formed from the shaped part of the present invention may include, for instance, pedal modules, instrument panels (e.g., dashboards), arm rests, consoles (e.g., center consoles), seat structures (e.g., backrest of the rear bench or seat covers), interior modules (e.g., trim, body panel, or door module), lift gates, interior organizers, step assists, ash trays, glove boxes, gear shift levers, etc. Other suitable products may include siding panels, fence picket parts, end caps, joints, hinges, trim boards for interior and exterior decoration, synthetic roofing shingles, slates, shakes or panels, etc.

The present invention may be better understood with reference to the following examples.

### Test Methods

Melt Flow Index: The melt flow index of a polymer or polymer composition may be determined in accordance with ISO 1133-1:2011 (technically equivalent to ASTM D1238-13) at a load of 2.16 kg and temperature of 230° C.

Volatile Organic Content (“VOC”): The total volatile organic content may be determined in accordance with an automotive industry standard test known as VDA 277:1995. In this test, for instance, a gas chromatography (GC) device may be employed with a WCOT-capillary column (wax type) of 0.25 mm inner diameter and 30 m length. The GC settings may be as follows: 3 minutes isothermal at 50° C., heat up to 200° C. at 12 K/min, 4 minutes isothermal at 200° C., injection-temperature of 200° C., detection-temperature of 250° C., carrier is helium, flow-mode split of 1:20 and average carrier-speed of 22-27 cm/s. A flame ionization detector (“FID”) may be employed to determine the total volatile content and a mass spectrometry (“MS”) detector may also be optionally employed to determine single volatile components. After testing, the VOC amount is calculated by dividing the amount of volatiles (micrograms of carbon equivalents) by the weight (grams) of the composition.

Toluene Volatile Organic Content (“TVOC”): The toluene-equivalent volatile organic content may be determined in accordance with an automotive industry standard test known as VDA 278:2002. More particularly, measurements may be made on a sample using a thermaldesoprtion analyzer (“TDSA”), such as supplied by Gerstel using helium 5.0 as carrier gas and a column HP Ultra 2 of 50 m length and 0.32 mm diameter and 0.52 μm coating of 5% phenylmethylsiloxane. The analysis may, for example, be performed using device setting 1 and the following parameters: flow mode of splitless, final temperature of 90° C.; final time of 30 min, and rate of 60 K/min. The cooling trap may be purged with a flow-mode split of 1:30 in a temperature range from −150° C. to +280° C. with a heating rate of 12 K/sec and a final time of 5 min. For analysis, the gas chromatography (“GC”) settings may be 2 min isothermal at 40° C., heating at 3 K/min up to 92° C., then at 5 K/min up to 160° C., and then at 10 K/min up to 280° C., 10 minutes isothermal, and flow of 1.3 ml/min. After testing, the TVOC amount is calculated by dividing the amount of volatiles (micrograms of toluene equivalents) by the weight (grams) of the composition.

Fogging Content (“FOG”): The fogging content may be determined in accordance with an automotive industry standard test known as VDA 278:2002. More particularly, measurements may be made on a sample using a thermaldesoprtion analyzer (“TDSA”), such as supplied by Gerstel using helium 5.0 as carrier gas and a column HP Ultra 2 of 50 m length and 0.32 mm diameter and 0.52 μm coating of 5% phenylmethylsiloxane. The analysis may, for example, be performed using device setting 1 and the following parameters: flow mode of splitless, final temperature of 120° C.; final time of 60 min, and rate of 60 Kim in. The cooling trap may be purged with a flow-mode split of 1:30 in a temperature range from −150° C. to +280° C. with a heating rate of 12 K/sec. For analysis, the gas chromatography (“GC”) settings may be 2 min isothermal at 50° C., heating at 25 K/min up to 160° C., then at 10 K/min up to 280° C., 30 minutes isothermal, and flow of 1.3 ml/min. After testing, the FOG amount is calculated by dividing the amount of volatiles (micrograms of hexadecane equivalents) by the weight (grams) of the composition.

Tensile Modulus, Tensile Stress, and Tensile Elongation at Break: Tensile properties may be tested according to ISO Test No. 527-1:2012 (technically equivalent to ASTM D638-14). Modulus and strength measurements may be made on a dogbone-shaped test strip sample having a length of 170/190 mm, thickness of 4 mm, and width of 10 mm. The testing temperature may be −30° C., 23° C., or 80° C. and the testing speeds may be 1 or 5 mm/min.

Flexural Modulus, Flexural Elongation at Break, and Flexural Stress: Flexural properties may be tested according to ISO Test No. 178:2010 (technically equivalent to ASTM D790-15e2). This test may be performed on a 64 mm support span. Tests may be run on the center portions of uncut ISO 3167 multi-purpose bars. The testing temperature may be −30° C., 23° C., or 80° C. and the testing speed may be 2 mm/min.

Unotched and Notched Charpy Impact Strength: Charpy properties may be tested according to ISO Test No. ISO 179-1:2010) (technically equivalent to ASTM D256-10, Method B). This test may be run using a Type 1 specimen size (length of 80 mm, width of 10 mm, and thickness of 4 mm). When testing the notched impact strength, the notch may be a Type A notch (0.25 mm base radius). Specimens may be cut from the center of a multi-purpose bar using a single tooth milling machine. The testing temperature may be −30° C., 23° C., or 80° C.

### EXAMPLE 1

A shaped part is formed by melt blending a first composition in amount of 50 wt. %, a second composition in an amount of 25 wt. %, and a third composition in an amount of 25 wt. %. The first composition contains 20 wt. % cellulosic fibers and 80 wt. % polypropylene, the second composition contains 60 wt. % long glass fibers and 40 wt. % polypropylene, and the third composition contains 100 wt. % of polypropylene. The resulting parts were tested and the average results are provided in the table below.

| | |
|---|---|
| Tensile Modulus (1 mm/min) (GPa) | 4.43 |
| Density (g/cm³) | 1.024 |
| Tensile Strength at Yield 50 mm/min (MPa) | 66 |
| Elongation at Break (%) | 2.46 |
| Flexural Modulus (GPa) | 4.64 |
| Impact Strength at 23 C., Notched Charpy (kJ/m²) | 11.48 |
| Impact Strength at −40 C., Notched Charpy (kJ/m²) | 12.37 |

### EXAMPLE 2

A shaped part is formed by melt blending a first composition in amount of 75 wt. % and a second composition in an amount of 25 wt. %. The first composition contains 20 wt. % cellulosic fibers and 80 wt. % polypropylene, and the second composition contains 60 wt. % long glass fibers and 40 wt. % polypropylene. The resulting parts were tested and the average results are provided in the table below.

| | |
|---|---|
| Tensile Modulus (1 mm/min) (GPa) | 4.04 |
| Density (g/cm³) | 1.044 |
| Tensile Strength at Yield 50 mm/min (MPa) | 62 |
| Elongation at Break (%) | 2.4 |
| Flexural Modulus (GPa) | 4.33 |
| Impact Strength at 23 C., Notched Charpy (kJ/m²) | 9.26 |
| Impact Strength at −40 C., Notched Charpy (kJ/m²) | 7.99 |

These and other modifications and variations of the present invention may be practiced by those of ordinary skill in the art, without departing from the spirit and scope of the present invention. In addition, it should be understood that aspects of the various embodiments may be interchanged both in whole or in part. Furthermore, those of ordinary skill in the art will appreciate that the foregoing description is by way of example only, and is not intended to limit the invention so further described in such appended claims.

What is claimed is:

1. A method for forming a shaped part, the method comprising:
melt blending a first polymer composition and a second polymer composition to form a molten blend, wherein the first polymer composition comprises a plurality of long inorganic fibers distributed within a first polymer matrix, and wherein the second polymer composition comprises a plurality of cellulosic fibers distributed within a second polymer matrix;
injecting the molten blend into a mold cavity; and
cooling the molten blend within the mold cavity to form the shaped part.

2. The method of claim 1, wherein the first polymer matrix constitutes from about 30 wt. % to about 80 wt. % of the first polymer composition and the long inorganic fibers constitute from about 20 wt. % to about 70 wt. % of the first polymer composition.

3. The method of claim 1, wherein the second polymer matrix constitutes from about 60 wt. % to about 95 wt. % of the second polymer composition and the cellulosic fibers constitute from about 5 wt. % to about 40 wt. % of the second polymer composition.

4. The method of claim 1, wherein the first polymer matrix, the second polymer matrix, or both contain a propylene polymer.

5. The method of claim 1, wherein the long inorganic fibers are glass fibers.

6. The method of claim 1, wherein the long inorganic fibers are oriented in a longitudinal direction of the first polymer composition.

7. The method of claim 1, wherein the long inorganic fibers in the first polymer composition have a length of from about 1 millimeter to about 25 millimeters.

8. The method of claim 1, wherein the cellulosic fibers in the second polymer composition have a length of about 1 millimeter or less.

9. The method of claim 1, wherein the first polymer composition constitutes from about 10 wt. % to about 50 wt. % of the molten blend and the second polymer composition constitutes from about 50 wt. % to about 90 wt. % of the molten blend.

10. The method of claim 1, wherein the molten blend is cooled for a time of from about 1 to about 60 seconds.

11. The method of claim 1, wherein the temperature of the mold cavity is from about 10° C. to about 60° C.

12. The method of claim 1, wherein the weight ratio of the second polymer composition to the first polymer composition within the molten blend is from about 1:1 to about 10:1.

13. An injection-molded part comprising a fiber-reinforced composition, wherein the composition comprises from about 40 wt. % to about 85 wt. % of a polymer matrix containing a propylene polymer, from about 8 wt. % to about 30 wt. % of glass fibers having a length of from about 1 millimeter to about 25 millimeters, and from about 5 wt. % to about 20 wt. % of cellulosic fibers.

14. An automotive component comprising the injection-molded part of claim 13.

15. The automotive component of claim 14, wherein the component is an interior automotive component.

16. The automotive component of claim 15, wherein the component is a pedal module, instrument panel, arm rest, console, seat structure, interior module, lift gate, interior organizer, step assist, ash tray, glove box, gear shift lever, or a combination thereof.

17. The automotive component of claim 14, wherein the automotive component is an exterior automotive component.

18. The automotive component of claim 17, wherein the component is a fan shroud, sunroof system, door panel, front end module, side body panel, underbody shield, bumper panel, cladding, cowl, spray nozzle body, capturing hose assembly, pillar cover, rocker panel, or a combination thereof.
